(19) United States
(12) Patent Application Publication
(10) Pub. No.: US 2014/0104096 A1
(43) Pub. Date: Apr. 17, 2014

(54) ELECTRONIC SYSTEM FOR THE IDENTIFICATION AND NEUTRALIZATION OF MENACES IN A PREDEFINED AREA

(71) Applicant: Carlo Alberto Iardella, Carrara (MS) (IT)

(72) Inventor: Carlo Alberto Iardella, Carrara (MS) (IT)

(73) Assignee: OTO MELARA SPA, La Spezia (IT)

(21) Appl. No.: 14/000,782

(22) PCT Filed: Feb. 21, 2011
(86) PCT No.: PCT/IB11/00332

§ 371 Date: Dec. 5, 2013

(51) Int. Cl. G01S 13/87; F41G 7/30; F41G 5/08

(52) U.S. Cl. CPC G01S 13/87; F41G 5/08; F41G 7/30
USPC 342/67

(57) ABSTRACT

An electronic system for the identification and the neutralization of menaces in a predefined area includes radar detection including at least three discovery radars (R1,R2,R3) arranged on the vertices of a triangle at a predefined distance among them within the area to be protected. A processing electronic unit (CPU) receives from each of the discovery radars information related to the ballistic menace, for recognizing the ones deriving from the same menace, for each of them, through a triangulation algorithm, for identifying three-dimensional position and speed.

The present invention refers to an electronic system for the identification and the neutralization of menaces in a predefined area. In particular, the present invention relates to a system designed to identify ballistic menaces, such as for example mortar shells or similar which can fall in this predefined area.

For this purpose, are known discovery radars which are systems using radio waves for detecting the distance, the position and the speed of objects in a predefined area.

The functioning principle of these systems provides that at determined regular intervals, a transmitter emits a radiofrequency pulse which is transmitted in the space through a strongly directional antenna (at least in the plane parallel to the ground, the so-called azimuth plane). Right after the emission, the same antenna is connected to a very sensitive receiver which listens to the reflected echo. If there is a target, the transmitted pulse is reflected and returns then to the antenna and is processed by the receiver. By measuring the time which passes between the transmission of the pulse and the return of the echo, it is possible to find at which distance there is the target, given that the speed at which the pulse propagates is known and is equal to the light speed.

The data combined of the orienting of the antenna at the moment of the emission of the pulse and of the time of the echo of the signal give the position of an object in the detecting field of the radar; the difference between two successive detections (or the Doppler displacement in a single detection, in the most recent models) determines the speed and the moving direction of the object detected. Upon the same principle applied in a different way (antenna which moves vertically) are based the aerial discovery radars, whereas the radars for guide systems of missiles are almost always Doppler radars able to discriminate, from the frequency displacement of the echo, the moving targets from the ground.

The Applicant has perceived that using at least three discovery radars in predetermined positions and correlating the data deriving from them according to a triangulation algorithm can be calculated the position and the height of the menace, its classification and the ballistic estimation.

The discovery radars are preferably arranged at the vertices of an equilateral triangle and the zone protected by this system is a zone substantially hemispherical whose centre corresponds to the centre of this triangle.

The characteristics and the advantages of the system according to the present invention will be more evident from the following description, exemplifying and not limiting, referred to the schematic drawings attached wherein:

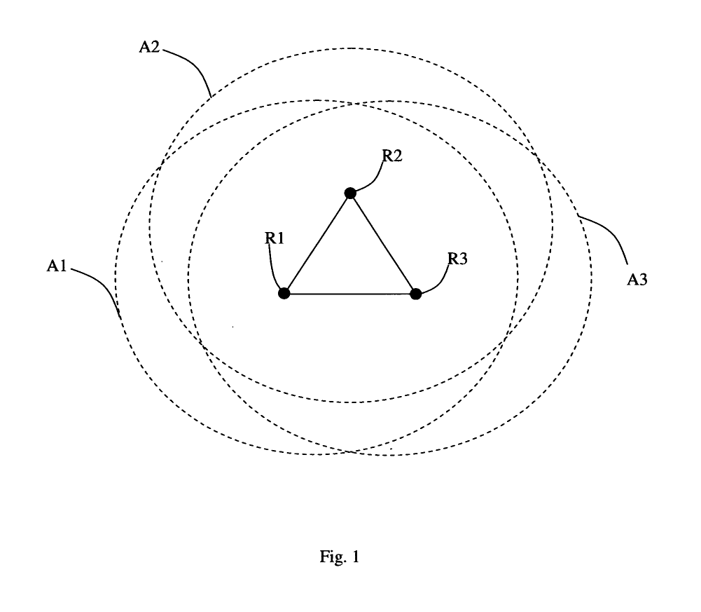

in FIG. 1 it is shown a schematic view seen from above of the positioning of the discovery radars and of the protection area of the system;

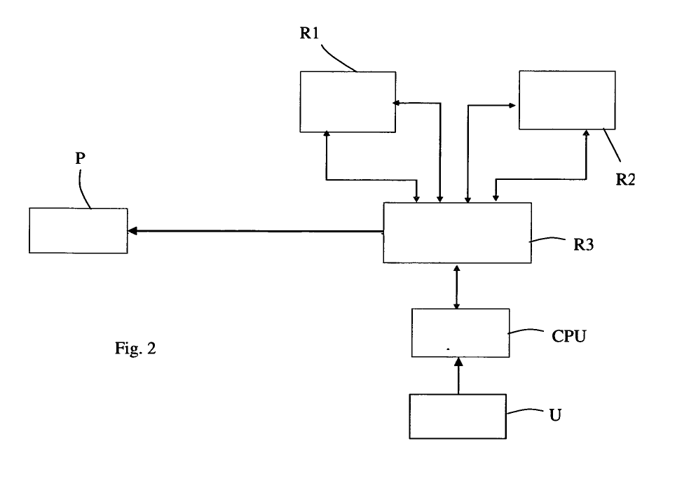

FIG. 2 shows a block diagram of the system according to the present invention.

With reference to the mentioned figures, the system according to the present invention comprises at least three discovery radars R1, R2 and R3 positionable on the vertices of a triangle at a predefined distance among them, within the area to be protected from one or more ballistic menaces. Preferably, the triangle is an isosceles triangle. Alternatively, the position of the radars can be different provided that the distance among the radars themselves is maximized for increasing the efficacy of the system. Furthermore, even the number of radars can be higher than three; as a matter of fact, with a higher number of radars, the accuracy of the measurement and of the dimension of the protected area can be increased.

Furthermore, the system according to the invention is able to detect contemporarily a relevant number of menaces, for example up to 128 menaces.

Each radar carries out a detection in a predetermined area A1, A2 and A3 and the most protected zone results to be the intersection of the three detection areas.

The block diagram of FIG. 2 shows the system in its entirety which comprises further than the three mentioned discovery radars also a processing electronic unit CPU which analyzes the data of the three radars and can be advantageously associated to one of the three radars, which becomes then the “primary” radar, whereas the remaining two become “secondary” radars. Furthermore, if one of the three radars undergoes a failure, breakdown or malfunctioning, the system automatically chooses one of the remaining radars as main radar.

An interface unit U acts as system operative console and communicates with this central processing unit.

Each discovery radar carries out a bidimensional detection, producing information on each ballistic menace, such as for example position data, for example distance, azimuth and radial speed.

The information produced by each radar is processed by the processing unit, which recognizes which information deriving from radar different among them refers to the same menace and it processes them through triangulation algorithms, obtaining the information related to the height of the target and of the under tracking targets. The system according to the present invention is able to detect as above described the ballistic menaces and to determine their three-dimensional position and speed, in such a way as to provide these data to a piloting device P for a weapon through which directing the fire of the weapon itself and neutralizing the menace.

By arranging the three discovery radars at nearly 500 meters the one from the other at the vertices of an isosceles triangle, detections can be carried out and menaces can be discovered in a hemispherical area having a radium equal to nearly 5 km and a maximum height comprised between 70 and 80 deg. Each discovery radar is preferably of “pulse Doppler” type.

1. Electronic system for identification and neutralization of ballistic menaces in a predefined area through radar detection comprising:
at least three discovery radars arranged on vertices of a triangle at a predefined distance among the discovery radars, within said predefined area, each discovery radar being arranged for carrying out a bidimensional detection, producing information on each ballistic menace, said information comprising distance, azimuth and radial speed;
a processing electronic unit for receiving from each of said discovery radars information related to the ballistic menace, and for recognizing ones deriving from the same menace, for each of the menaces identifying three-dimensional position and speed through a triangulation algorithm, to provide said data to a control device for a weapon through to direct firing of the weapon and neutralizing the menace.

2. The system according to claim 1, wherein each discovery radar is a pulse Doppler radar.

3. The system according to claim 1, wherein said triangle is an isosceles triangle.

4. The system according to claim 1, wherein said processing unit is associated to one of the three discovery radars that becomes the main radar whereas the other two radars become secondary radars.

5. The system according to claim 1, wherein an interface unit acts as system operative console and communicates with said central processing unit.
